(19) United States
(12) Patent Application Publication
(10) Pub. No.: US 2016/0344901 A1
(43) Pub. Date: Nov. 24, 2016

(54) IMAGE PROCESSING APPARATUS, METHOD, AND RECORDING MEDIUM

(71) Applicant: Naoya AWAMURA, Kanagawa (JP)

(72) Inventor: Naoya AWAMURA, Kanagawa (JP)

(73) Assignee: Ricoh Company, Ltd., Tokyo (JP)

(21) Appl. No.: 15/151,811

(22) Filed: May 11, 2016

(30) Foreign Application Priority Data
May 21, 2015 (JP) 2015-103927

(51) Int. Cl. H04N 1/60; H04N 1/54; B41M 5/00; H04N 1/52

(52) U.S. Cl. CPC H04N 1/6008; H04N 1/52; H04N 1/54; B41M 5/0023

(57) ABSTRACT

An image processing apparatus includes circuitry to acquire color information of an image to be processed, the image to be processed having a first region to be formed in a fluorescent color and a second region to be formed in a color other than the florescent color, obtain attribute information associated with the first region to be formed in the fluorescent color, and generate a plane that corresponds to the first region to be formed in the fluorescent color in the image to be processed based on the obtained attribute information.

### CROSS-REFERENCE TO RELATED APPLICATION

This patent application is based on and claims priority pursuant to 35 U.S.C. §119(a) to Japanese Patent Application No. 2015-103927, filed on May 21, 2015, in the Japan Patent Office, the entire disclosure of which is hereby incorporated by reference herein.

### BACKGROUND

1. Technical Field

The present disclosure relates to an image processing apparatus, a method for processing an image, and a non-transitory recording medium storing program code for causing an image processing apparatus to perform a method for processing an image.

2. Description of the Related Art

In the field of offset printing, an image forming process known as five-color separation printing forms an image with five different color inks, that is, cyan, magenta, yellow, black (CMYK) plus either fluorescent pink (referred to as “KP”, hereinafter) or fluorescent yellow (referred to as “KY”). Further, another image forming process known as florescent-color replacement printing forms an image with four different color inks, that is, CYK plus KP, where the basic magenta ink is replaced with the fluorescent pink ink, or CMK plus KY, where the basic yellow ink is replaced with the fluorescent yellow ink.

With five-color separation printing, skin color is reproduced with brightness. Accordingly, this process is effective for printed matter for certain specific fields. With fluorescent-color replacement printing, by contrast, there is no need to prepare a plane dedicated to a fluorescent color, thereby reducing printing costs. In addition, recent Print on Demand (POD) equipment often employs a printing process using fluorescent color toner. Accordingly, the five-color separation process can be used with relatively low cost.

### SUMMARY

An image processing apparatus includes circuitry to acquire color information of an image to be processed, the image to be processed having a first region to be formed in a fluorescent color and a second region to be formed in a color other than the florescent color, obtain attribute information associated with the first region to be formed in the fluorescent color, and generate a plane that corresponds to the first region to be formed in the fluorescent color in the image to be processed based on the obtained attribute information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating a schematic configuration of an image processing apparatus according to an exemplary embodiment of the present invention;

FIG. 2 is a block diagram illustrating an exemplary hardware configuration of a digital front end (DFE) of the image processing apparatus of FIG. 1;

FIG. 3 is a block diagram illustrating a schematic configuration of the DFE of the image processing apparatus of FIG. 1;

FIG. 4 is a block diagram illustrating a schematic configuration of a rendering engine of the DFE of the image processing apparatus of FIG. 1;

FIG. 5 is an illustration for describing an object editing tool of desktop publishing (DTP) application software when setting a type of fluorescence according to an exemplary embodiment of the present invention;

FIG. 6 is a flowchart illustrating an operation of generating a fluorescence plane according to an exemplary embodiment of the present invention, and

FIG. 7 is an illustration for describing a specific example where the fluorescence plane is generated according to an exemplary embodiment of the present invention.

The accompanying drawings are intended to depict example embodiments of the present invention and should not be interpreted to limit the scope thereof. The accompanying drawings are not to be considered as drawn to scale unless explicitly noted.

### DESCRIPTION OF THE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the present disclosure is not intended to be limited to the specific terminology so selected and it is to be understood that each specific element includes all technical equivalents that operate in a similar manner.

Exemplary embodiments of the present invention will be described hereinafter with reference to drawings. In the drawings for describing the following embodiment, the same reference numbers are allocated to elements (members or components) having the same function or shape and redundant descriptions thereof are omitted below.

An image processing apparatus 100 according to an embodiment includes a digital front end (DFE) 10 that converts an electronically created document (document data) described in a programing language such as a page description language (PDL) to rendered image data that can be printed by a printer 30. Note that such image processing apparatus 100 including the DFE 10 is just one example, and the embodiments of the present invention is applicable to any image processing apparatus that includes a control apparatus for controlling another device that forms an image

This exemplary embodiment relates to a process of generating a fluorescence plane by the DFE 10. In this embodiment, using application software for electronically creating the document, attribute information of a region in which a fluorescent color is to be used is specified in advance for a part of the document data having color information. In this exemplary embodiment, in rendering, the DFE 10 automatically generates the fluorescence plane based on the attribute information. This exemplary embodiment will be described in detail hereinafter with reference to the drawings.

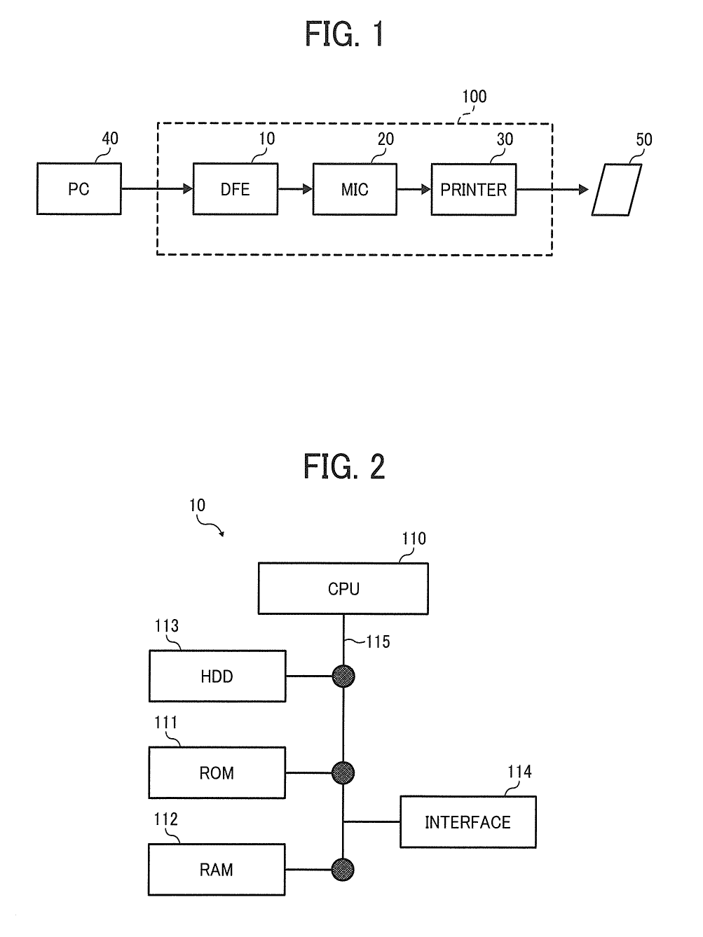

First, a description is given of a schematic configuration of the image processing apparatus 100 according to this exemplary embodiment. FIG. 1 is a block diagram illustrating an exemplary schematic configuration of the image processing apparatus 100.

As illustrated in FIG. 1, the image processing apparatus 100 includes the DFE 10 as a print control device, a mechanism interface controller (MIC) 20 as an interface controller, and a printer 30.

The DFE 10 communicates with the printer 30 via the MIC 20 to control image formation by the printer 30. Further, a personal computer (PC) 40 as an information processing apparatus is connected to the DFE 10 for controlling operation of the DFE 10. The PC 40 and the DFE 10 may be connected to each other via a network. The PC 40 creates the document data described in the programming language such as the PDL, with application software installed on the PC 10 in advance. The PC 40 sends the document data to the DFE 10.

The DFE 10 converts the document data described in the programming language such as the PDL received from the PC 10 to image data rendered in a format that can be printed by the printer 30, and sends the converted image data to the printer 30 via the MIC 20. Hereinafter, a description is given of a hardware configuration of the DFE 10 according to this exemplary embodiment. FIG. 2 is a block diagram illustrating an exemplary hardware configuration of the DFE 10. The DFE 10 has a hardware configuration implemented by a general computer.

As illustrated in FIG. 2, the DFE 10 includes a central processing unit (CPU) 110 that controls entire operation of the DFE 10. The DFE 10 further includes a main memory for storing various data and programs, such as a read only memory (ROM) 111 and a random access memory (RAM) 112. The DFE 10 further includes an auxiliary memory for storing various data and programs, such as a hard disk drive (HDD) 113.

The DFE 10 further includes an interface 114 for connecting the DFE 10 with the PC 40 and MIC 20. The CPU 110, the ROM 111, the RAM 112, the HDD 113, and the interface 114 are connected to one another via a bus 115. The CPU 110 executes the programs stored in the ROM 111, the RAM 112, or the HDD 113 to implement various processes by the DFE 10. Alternatively, at least a part of the functions of the DFE 10 may be implemented by circuitry such specific hardware.

Referring back to FIG. 1, the printer 30 forms an image with at least one toner of fluorescent color in addition to four color toners of CMYK. The printer 30 includes a plurality of image formation units each corresponding to a different color toner, an exposure device, and a fixing device. The image formation unit includes a photoconductor, a charging device, a developing device, and a photoconductor cleaner. The printer 30 causes the exposure device to emit a light rays defined by the image data sent from the DFE 10 via the MIC 20 to form a toner image of each color on the photoconductor.

Then, the printer 30 transfers the toner images of the different colors formed on the photoconductors onto a transfer paper, overlaid one atop the other. The toner image transferred onto the transfer paper is fixed thereon by the fixing device with heat and pressure. Thus, an image is formed on the transferred paper, and a desired printed matter 50 is obtained.

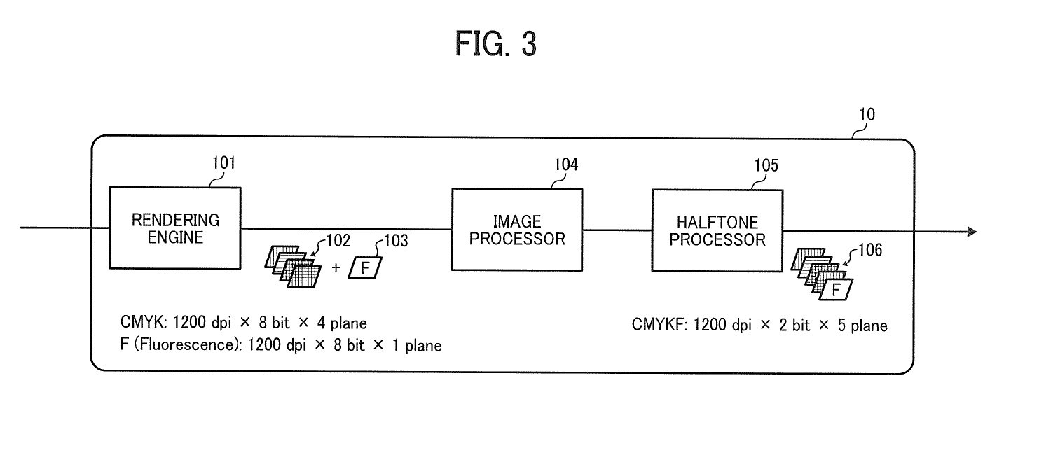

Hereinafter, a description is given of a schematic configuration of the DFE 10 according to this exemplary embodiment. FIG. 3 is a block diagram illustrating an exemplary configuration of the DFE 10.

As illustrated in FIG. 3, the DFE 10 includes a rendering engine 101, an image processor 104, and a halftone processor 105. The rendering engine 101 interprets the document data created on the PC 40 as described above with reference to FIG. 1. The rendering engine 101 also carries out vector-raster conversion and color conversion to CMYK. The vector-raster conversion is a process of converting vector data (lines or shapes) to image data (pixels or dots). The resolution of rendering in the vector-raster conversion may be, for example, 1200 dots per inch (dpi). The rendering involves processing by a computer to display an appearance of a screen or an image from data constituted by characters, numerical values, equations, etc., describing a content of the appearance of the screen or the image.

The rendering engine 101 executes each process described above to output image data of four different color planes 102 of CMYK, each having a data size of 8 bits. The rendering engine 101 also generates image data of a fluorescence plane 103, when the printing with the fluorescent ink is to be performed. Thus, a pixel value of the image data output from the rendering engine 101 is 1200 dpi*8 bit*4 plane (CMYK) plus 1200 dpi*8 bit* 1 plane (fluorescence). The plane here means the concept of a color component, which is a transparent plane to which the appearance of the image is to be affixed.

The rendering engine 101 determines the pixel value of the image data of the fluorescence plane 103 based on a fluorescence type of attribute information embedded in the image data created by the PC 40. The fluorescence type of the attribute information and an operation of determining the pixel value of the image data of the fluorescence plane will be described later in detail.

The image processor 104 applies the image data output from the rendering engine 101 with gamma correction for calibration, and toner amount control for regulating a total amount of the CMYKF toners. The gamma correction is a process of adjusting a relation between color data of an image or the like and output signals, which are generated when the color data is output for display, to obtain a display that is more natural in appearance.

The halftone processor 105 converts a foimat of the 8-bit image data that is output from the image processor 104 to a data format for output to the printer 30. Specifically, an image data 106 including five pieces of 2-bit image data of the CMYKF planes is obtained. The DFE 10 sends the image data 106 of 1200 dpi*2 bit*5 plane (CMYKF) to the MIC 20.

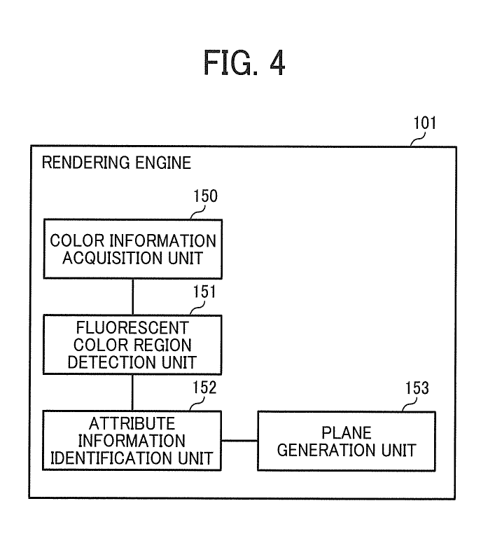

Hereinafter, a description is given of a schematic configuration of the rendering engine 101 of the DFE 10 according to this exemplary embodiment. FIG. 4 is a block diagram illustrating an exemplary functional configuration of the rendering engine 101.

The rendering engine 101 includes a color information acquisition unit 150, a fluorescent color region detection unit 151, an attribute information identification unit 152, and a plane generation unit 153. The color information acquisition unit 150 acquires color information of a pixel to be processed in an image to be processed. Hereinafter, the pixel to be processed will be also referred to as a “target pixel”. The fluorescent color region detection unit 151 distinguishes a region to be formed in a fluorescent color from a region to be foimed in either one of CMYK colors in the image to be processed as described later.

The attribute information identification unit 152 identifies the attribute information that is specified in advance for an image of the region to be formed in a fluorescent color as described later. The plane generation unit 153 generates a plane that corresponds to the region to be formed in a fluorescent color in the image to be processed based on the attribute information identified by the attribute information identification unit 152 as described later.

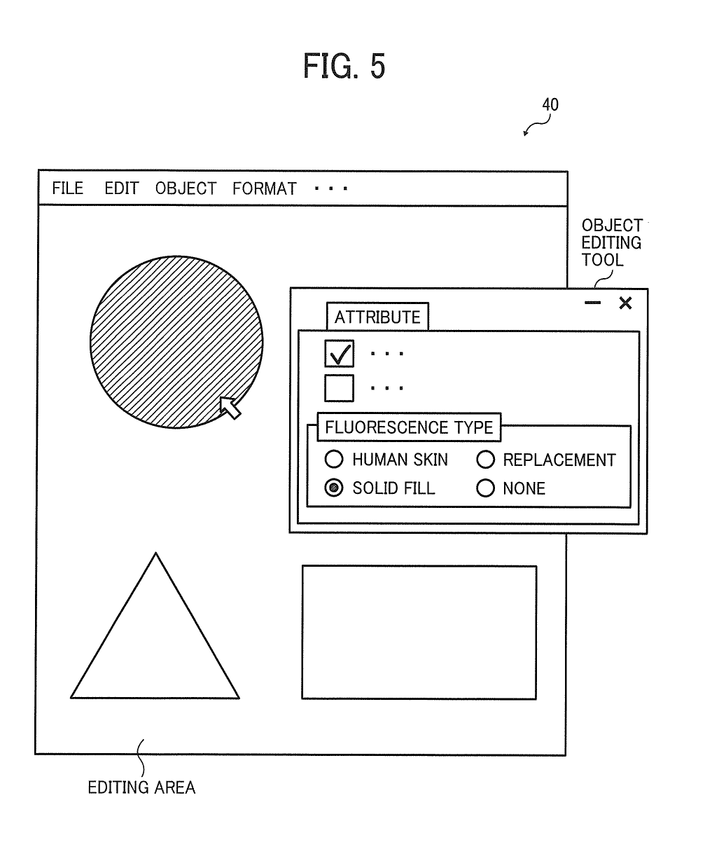

Hereinafter, a description is given of an object editing tool of desktop publishing (DTP) application software when setting the fluorescence type according to this exemplary embodiment. FIG. 5 is an illustration for describing the object editing tool of the DTP application software when setting the fluorescence type.

The DTP is the production of a printed matter by means of a computer in cooperation with software for electronically creating and editing documents, specifying designs or layouts, and generating planes. The PC 40 is implemented by, for example, a general personal computer having a hardware configuration including a memory such as a ROM, a RAM, and an HDD, a processor such as a CPU, an input device such as a keyboard or a mouse for receiving an instruction from a user, and a display. The DTP application software is stored in the ROM or the HDD of the PC 40, and loaded to the RAM. The processor of the PC 40 executes the DTP application software using the RAM as a work area to implement functions provided by the DTP application software as described below. General DTP application software allows a user to edit color information and other attribute information object by object such as characters or figures when creating the document data. In this embodiment, function expansion of the DTP application software allows the user to set the fluorescence type as one item of attribute information. This attribute information specifies a region in which fluorescent colorant is to be used for printing. In addition, this attribute information also specifies a use of the fluorescent color. The attribute information is specified via a menu provided by the object editing tool of the DTP application software installed in the PC 10 in advance.

When the DTP application software is activated, as illustrated in FIG. 5, the PC 40 displays an editing area that allows a user to edit the document data being displayed for preview. The user selects a desired object of the document data in the editing area, and instructs a display of the attribute information, for example, using a mouse. In response to such instruction, the DTP application software displays a menu of the object editing tool as illustrated in FIG. 5. The menu includes an attribute tab to receive a user's selection of the attribute information that can be specified in this exemplary embodiment. The DTP application software in this example has the extended function of setting the fluorescence type as illustrated in a lower portion of the menu of the object editing tool. Such extended function of setting the fluorescence type is implemented by, for example, plug-in software. The plug-in software means software that is added to an existing application program to extend the function of the existing application program. Information on the fluorescence type selected by the user in the attribute tab is set for every pixel in a region where the desired object selected by the user is present, as attribute information for every pixel in that region.

As illustrated in FIG. 5, the fluorescence types that can be specified as the attribute information include a “HUMAN SKIN”, “SOLID FILL”, and REPLACEMENT”. The “HUMAN SKIN” is a primary use of KP ink. The “SOLID FILL” is suitable for solid characters or figures. The “REPLACEMENT” is specified for executing processing substantially similar to that of the fluorescent-color replacement printing described above. The fluorescence types also include “NONE”, which is selected when only CMYK colors are used. The attribute information is embedded in the document electronically created with the DTP application software installed on the PC 40. The document data thus includes, in addition to at least color information for each pixel, the attribute information including information on the fluorescence type. The electronically created document in which the attribute information is embedded is input to the DFE 10 from the PC 40 using a printer driver or via prepress software application. Alternatively, the DFE 10 may acquire the electronically created document from the PC 40 according to an instruction input via a graphical user interface (GUI). The rendering engine 101 of the DFE 10 generates the fluorescence plane 103 using the attribute information. In other words, the attribute information is set in advance according to the use of the image of the region to be formed in the fluorescent color.

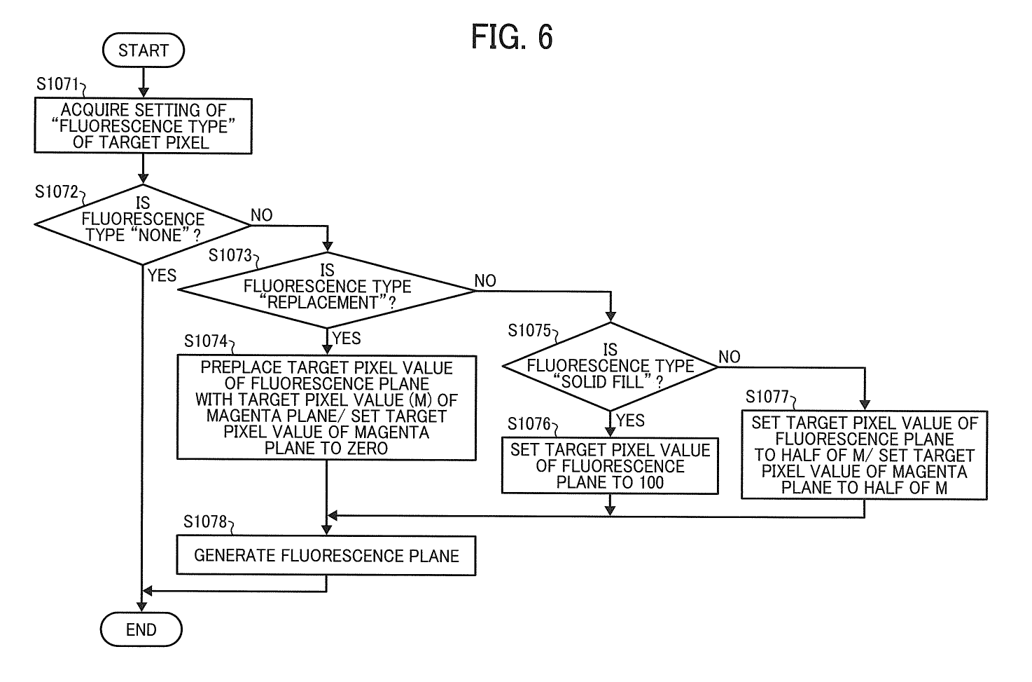

Hereinafter, a description is given of an operation of generating the fluorescence plane 103 according to this exemplary embodiment. FIG. 6 is a flowchart illustrating an operation of generating the fluorescence plane 103.

When the generation of the fluorescence plane 103 is started, at S1071, the color information acquisition unit 150 of the rendering engine 101 acquires the setting of the fluorescence type of the target pixel specified as an item of the attribute information in the document electronically created by the PC 40. At S1072, the fluorescent color region detection unit 151 of the rendering engine 101 determines whether the acquired setting of the fluorescence type is “NONE”. When the fluorescence type is not “NONE” (S1072: NO), the processing proceeds to S1073. When the fluorescence type is “NONE” (S1072: YES), the processing ends because no fluorescence plane 103 is to be generated.

At S1073, the attribute information identification unit 152 of the rendering engine 101 determines whether the setting of the fluorescence type is the “REPLACEMENT”. When the setting of the fluorescence type is the “REPLACEMENT” (S1073: YES), the processing proceeds to S1074. At S1074, the plane generation unit 153 of the rendering engine 101 sets the target pixel value of the fluorescence plane 103 to the target pixel value “m” of the magenta plane. In addition, the plane generation unit 153 sets the target pixel value of magenta plane to zero. Thus, substantially the similar output to that of the fluorescent-color replacement printing as described above is obtained.

When the setting of the fluorescence type is not the “REPLACEMENT” (S1073: NO), the processing proceeds to S1075. At S1075, the attribute information identification unit 152 determines whether the setting of the fluorescence type is the “SOLID FILL”. When the setting of the fluorescence type is the “SOLID FILL” (S1075: YES), the processing proceeds to S1076. At S1076, the plane generation unit 153 sets the target pixel value of the fluorescence plane 103 to 100%. In this case, the target pixel value of magenta plane is not changed. Thus, the colorants of fluorescent color and magenta are mixed with each other, and a vivid and bright output is obtained. This output is suitable for solid characters or figures.

When the setting of the fluorescence type is not the “SOLID FILL” (S1075: NO), the attribute information identification unit 152 identifies the setting of the fluorescence type as the “HUMAN SKIN”. Then, the processing proceeds to S1077. At S1077, the plane generation unit 153 sets the target pixel value of the fluorescence plane 103 to a half (i.e., m/2) of the target pixel value “m” of the magenta plane. In this case, the target pixel value of magenta plane is also set to m/2. Thus, the output close to that of the five-color separation printing using KP ink as described above is obtained. The target pixel value that is set at S1077 may be finely adjusted according to the type of colorants or documents.

All pixels are once subjected to the processes at S1074, S1076 and S1077 of determining the pixel value of the fluorescence plane 103. At S1078, the plane generation unit 153 generates the fluorescence plane 103 using the pixel values deteiinined at S1074, S1076 and S1077. Then, the processing ends. As described heretofore, in this exemplary embodiment, the pixel value of the fluorescent color constituting the image to be processed is changed.

In the example described above with reference to FIG. 6, the pixel value is changed to a fixed value such as zero, m/2, or 100%. However, the pixel value may be set to any values other than the fixed value. The user may set the pixel value to any arbitrary value using a user interface provided with the PC 40 so that the user can obtain satisfactory image quality.

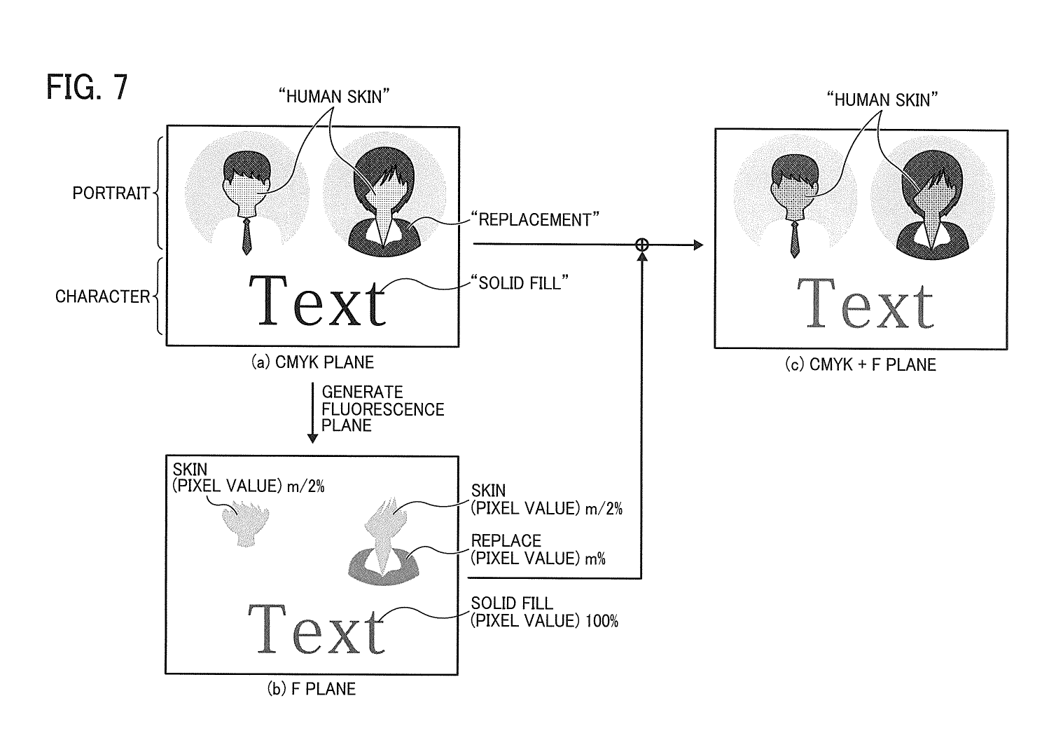

Hereinafter, a description is given of a specific example where the fluorescence plane 103 is generated according to this exemplary embodiment. FIG. 7 is an illustration for describing the specific example where the fluorescence plane 103 is generated.

In the example as illustrated in (a) of FIG. 7, the document electronically created by the PC 40 and input to the DFE 10 includes and human portraits and letters. In this case, the user sets in advance the fluorescence type as the attribute information for a region to which the user wants to give a prominence in the CMYK planes 102 as illustrated in (a) of FIG. 7. For example, the fluorescent type of “SKIN” is set as the attribute information for skin regions in the portraits (corresponding to S1077 of FIG. 6). Further, the fluorescent type of “REPLACE” is set as the attribute information for a bright color region of a clothing (corresponding to S1074 of FIG. 6). Further, the fluorescent type of “SOLID FILL” is set as the attribute information for the region of the letters (corresponding to S1076 of FIG. 6).

The rendering engine 101 generates the fluorescence plane 103 as illustrated in (b) of FIG. 7 based on the fluorescence types set as the attribute information. The CMYK planes 102 as illustrated in (a) of FIG. 7 and the fluorescence plane 103 as illustrated in (b) of FIG. 7 are superimposed on one another. Thus, as illustrated in the (c) of FIG. 7, an image having coloring of high quality is output with the five-color separation printing. As described heretofore, according to this exemplary embodiment, even in a case where the document electronically created on the PC 40 with the DTP application software does not include the plane for fluorescent color, the image data for the fluorescent color printing is obtained by specifying the appropriate attribute information for each image to be processed in the document data.

Each operation illustrated in FIG. 6 by the functional units constituting the image processing apparatus 100 according to this exemplary embodiment may be executed with a program on a computer. In other words, the CPU 110 of DFE 10 loads the programs stored in the ROM 111, the RAM 112, and the HDD 113. Then, each processing step of the programs is executed sequentially.

As described above, according to this exemplary embodiment, the attribute information of the region for which the fluorescent color is to be used is specified in advance in addition to the color information with the application software for creating the document data. The fluorescence plane 103 is generated based on the pixel value of the attribute information when the DFE 10 carries out rendering. Accordingly, even in a case where the document data does not include the plane of the fluorescent color, a printed matter having coloring of high quality is obtained with the five-color separation printing with a simple configuration.

Thus, according to embodiments of the present invention, the image processing apparatus, the method for processing an image, and the non-transitory program enable the production of the printed matter having coloring of high quality without preparing the plane for fluorescent color when electronically creating the document, even in a case where the image to be processed includes a region for which a colorant property of fluorescent color is necessary.

Numerous additional modifications and variations are possible in light of the above teachings. It is therefore to be understood that, within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An image processing apparatus, comprising circuitry to:
acquire color information of an image to be processed, the image to be processed having a first region to be formed in a fluorescent color and a second region to be formed in a color other than the florescent color;
obtain attribute information associated with the first region to be formed in the fluorescent color; and
generate a plane that corresponds to the first region to be formed in the fluorescent color in the image to be processed based on the obtained attribute information.

2. The image processing apparatus according to claim 1, further comprising a receiver to receive the image to be processed from an information processing apparatus,
the image to be processed including the attribute information that is specified based on a user instruction according to a type of the image of the first region to be formed in the fluorescent color.

3. The image processing apparatus according to claim 1, wherein the circuitry changes a value of a pixel of the fluorescent color that constitutes the image to be processed to generate the plane.

4. The image processing apparatus according to claim 3, wherein the value of the pixel is changed in response to a user instruction input via a menu.

5. The image processing apparatus according to claim 3, wherein the value of the pixel is determined in advance according to a use of the fluorescent color as an item of the attribute information in response to a user instruction input via a menu.

6. A method for processing an image by an image processing apparatus, the method comprising:
acquiring color information of an image to be processed, the image to be processed having a first region to be formed in a fluorescent color and a second region to be formed in a color other than the florescent color;
obtaining attribute information associated with the first region to be formed in the fluorescent color; and
generating a plane that corresponds to the first region to be formed in the fluorescent color in the image to be processed based on the obtained attribute information.

7. A non-transitory machine-readable recording medium storing program code for causing an image processing apparatus to perform a method for processing an image, the method comprising:
acquiring color information of an image to be processed, the image to be processed having a first region to be formed in a fluorescent color and a second region to be formed in a color other than the florescent color;
obtaining attribute information associated with the first region to be formed in the fluorescent color; and
generating a plane that corresponds to the first region to be formed in the fluorescent color in the image to be processed based on the obtained attribute infoimation.
